(19) United States
(12) Patent Application Publication
(10) Pub. No.: US 2019/0202316 A1
(43) Pub. Date: Jul. 4, 2019

(54) BATTERY CHARGING DEVICE AND METHOD FOR VEHICLE

(71) Applicant: Jeong Yong LEE, Hanam-si, Gyeonggi-do (KR)

(72) Inventor: Jeong Yong LEE, Hanam-si, Gyeonggi-do (KR)

(21) Appl. No.: 16/302,102

(22) PCT Filed: May 16, 2017
(86) PCT No.: PCT/KR2017/005078

§ 371 Date: Mar. 18, 2019

(30) Foreign Application Priority Data
May 16, 2016 (KR) 10-2016-0059865
May 19, 2016 (KR) 10-2016-0061716
Jun. 22, 2016 (KR) 10-2016-0078128
Jul. 9, 2016 (KR) 10-2016-0087199
May 15, 2017 (KR) 10-2017-0060204

(51) Int. Cl. B60L 53/80; B60L 53/16

(52) U.S. Cl. CPC B60L 53/80; B60L 53/16; B60L 2200/18; B60L 2200/32; B60L 2200/10

(57) ABSTRACT

A battery-charging device includes: a plug-and-socket-type power connection device for installing a battery inside a vehicle including an electric vehicle (including a passenger car, a bus, and a truck), a plug-in hybrid vehicle, a general vehicle, an electric aircraft, an electric vessel, or an electric submarine, wherein the battery of the vehicle is wholly removed from a position at which the battery is installed and is then inserted into the position at which the battery is installed and is connected to the plug-and-socket-type power connection device.

### TECHNICAL FIELD

The present invention relates to a battery-charging method of an electric vehicle, a hybrid electric vehicle, a plug-in hybrid electric vehicle, an electric bus, an electric truck, an electric aircraft, an electric vessel, an electric submarine, or the like.

Aug. 9, 2014

New technology electric vehicles have rapidly emerged in the Korean automobile market. At this time, there is the emergence of a so-called a plug-in hybrid electric vehicle that uses both a gasoline engine and an electric motor charged by an external power source. Needless to say, the plug-in hybrid electric vehicle has higher fuel efficiency than a hybrid vehicle and is capable of travelling more rapidly and farther than a pure electric vehicle. Foreign companies were first to release new models to the market, after which Korean automobile companies began to compete.

The BMW i8 plug-in hybrid vehicle is first introduced in Korea in October 2014.

The vehicle has fuel efficiency of 47.6 km per liter and a maximum speed of 250 km per hour.

While the vehicle travels in an electric-vehicle mode, if battery power is consumed, it is possible to simultaneously drive the vehicle and recharge the battery using an engine thereof.

The vehicle is capable of being driven using only electricity a maximum distance of 37 km and, thus, it is possible to drive the vehicle in an electric mode without using any fuel.]

In early 2015, the A3e-tronplug-in hybrid vehicle from Audi was introduced in Korea.

When sufficient infrastructure for charging electric vehicles is provided, demand for such vehicles is predicted to be high.]

Toyota has considered introducing the ‘Prius PHV’, which has set the record for fuel efficiency at 247 km per liter in a test, in Korea.

When a cable is connected to a charging port, located on the opposite side of the vehicle relative to a fuel filler inlet, it is possible to charge an electric vehicle using a general 220V socket, unlike other electric vehicles.

In the case in which such a vehicle is driven in a place with no charging equipment, anxiety of the driver is alleviated.

Although there is a flood of such imported cars, Korean automobile companies are also joining the race.

Hyundai/Kia, which released the electric vehicle ‘Soul EV’ in 2014, is expected to release a plug-in hybrid vehicle in the compact car class in 2015.

As plug-in hybrid vehicles compete in the pure electric vehicle market, competition for the leading position in the field of eco-friendly vehicles has gradually intensified.

Aug. 9, 2014

Recently, in the automobile business, the development of electric vehicles has concentrated on plug-in hybrid vehicles

Competition between new cars imported into Korea as of late 2014 has also concentrated on plug-in hybrid vehicles.

The development of plug-in hybrid vehicles is desperately required in order to enhance the competitiveness of the Korean automobile industry.

This is because a plug-in hybrid vehicle relies on the current competitiveness of an internal combustion engine, which is different from a pure electric vehicle.

[Phil Su KIM/Professor from the department of automobiles of Daelim University: A plug-in hybrid vehicle is considered as a model presenting a good opportunity for Korean automobile companies to take the initiative while maintaining the continuity of the automobile industry.]

However, plug-in hybrid vehicles do not fall in the category of government-sponsored electric vehicles.

[Official from Ministry of Environment: Because plug-in hybrid vehicles have not been vetted, we first established a framework for supporting pure electric vehicles (EV) in 2014.]

Whether to implement the support plan with founding support for low CO₂ vehicles is unclear.

There is a problem of insufficient infrastructure for charging electric vehicles.

Currently, there are 1,900 charging stations in total throughout Korea, and the charging stations are frequently useless because they are not appropriately managed after being constructed.

It has been pointed out that it is imperative to increase supportive measures and institutional practices so that the competitiveness of the industry is not damaged in the process of transitioning to next-generation vehicles.

### BACKGROUND ART

### Background Art of the Present Invention

[Battery Cell]

A combination of anode and cathode plates in a battery forms one set and is immersed in an electrolyte in the case of one cell separated from another cell.

One cell of a vehicle battery represents a voltage of 2 volts.

Accordingly, a battery outputting 12 volts includes six cells.

BMW-Samsung SDI, Execution of MOU for expansion of supply of electric vehicle batteries

Jul. 15, 2014 11:02:06

Execution of MOU of BMW GROUP-Samsung SDI

[Reporter, Han sung LEE from Daily car] BMW GROUP signs memorandum of understanding (MOU) for expanding the supply of electric vehicle battery cells with Samsung SDI in the BMW driving center of Youngjong-do, Incheon, in July 14.

BMW GROUP and Samsung SDI express their intention to increase the mid- and long-term supply of battery cells to respond to an increase in the demand for electric vehicles through the MOU and to strengthen cooperation for the development of related technologies.

BMW GROUP is expected to be supplied with battery cells for the BMW i3, BMW i8, and new hybrid models from Samsung SDI for several years.

Dr. Klaus Draeger, member of the Board of Directors of BMW GROUP responsible for Purchasing and Supplier Networks, says “Our partnership with Samsung SDI is a good example of successful Korean-German cooperation on innovative technologies.” and “The battery is a key component of every electric vehicle since it fundamentally determines the range and performance capabilities of the car. In Samsung SDI, we have chosen the supplier that offers us the best available technology with forward-looking Korean battery expertise.”

“Following successful cooperation in supplying batteries for the BMW i3 and i8, the installation of Samsung SDI's outstanding lithium ion batteries in additional BMW models is indicative of Samsung SDI's future technology and production capacity,” said Park Sang-jin, CEO of Samsung SDI. “Both companies are confident that expansion of the partnership will greatly contribute to gaining an edge in future electric vehicle technologies.”

BMW GROUP entered into a partnership with Samsung SDI back in 2009, and has since been receiving lithium ion batteries for the BMW i3 and i8 from Samsung SDI. Also, since the successful launch of the BMW i sub-brand, BMW has been reinforcing its electrification strategy. As a matter of fact, the BMW i3 has become very popular all over the world since its release, and the BMW i8 has enjoyed higher demand than originally anticipated.

Yoon Sang-jik, the Minister of Trade, Industry and Energy attending the MOU ceremony on that day, said, “Great synergy will be created out of the partnership between Samsung SDI, the best battery producer representing Korea, and the BMW Group, the premium automobile company in Germany. Joint growth of medium and small-sized companies is also expected. The Korean government will make its best efforts to enhance the partnership between the two countries as a representative example and also to support this partnership, so this could be an opportunity for companies in Korea and Germany to enhance cooperation in other industries as well.”

A next-generation battery developed in Japan has attracted attention in the automobile industry because the developed battery has been gradually recognized as one of the batteries that may help bring about the age of popularization of electric vehicles.

According to the U.S. Energy technical journal, Green Energy News and automobile journal, Car Advice, etc., the Japanese electric battery company Power Japan Plus has released a battery named Ryden Battery.

This next-generation battery has been released by Power Japan Plus in San Francisco, U.S., and is known to have very high efficiency compared with existing batteries.

Most currently introduced electric vehicles use a lithium-ion battery installed therein. A lithium-ion battery has a high battery discharge rate, which impedes the commercialization of electric vehicles. In contrast, the Ryden Battery is formed of organic cotton with a modified carbon fiber structure. Accordingly, the Ryden Battery achieves a high charging rate and a low discharge rate. In addition, the Ryden Battery is known to be capable of being repeatedly recharged and discharged 3000 times or more. Power Japan Plus forecasts that it will be possible to drive a vehicle for about 483 km on a single charge.

Dou Kani, CEO and co-founder of Power Japan Plus, said “Ryden Battery will greatly contribute to the popularization of electric vehicles”.

Electric Automobile

A vehicle driven by an electric motor that receives energy from a battery.

Heating fuel tank: A container for storing fuel for a heating device.

Traction battery: A battery for generating potential of 120 V and supplying driving force to a vehicle.

Electronic control box: An electric apparatus for switching energy exchange between a battery and an electric motor depending on a command from a driver and the traffic situation.

Charging plug: A plug for connecting a vehicle to main power or a specially provided terminal to charge a battery.

Auxiliary battery: A battery to be charged using the traction battery. This generates potential of 12V and supplies the potential to accessories of an electric apparatus.

Transmission: An apparatus for transmitting the rotary motion of a motor to a wheel.

Traction batteries: A battery for generating potential of 120 V and supplying driving force to a vehicle.

Electric motor: An apparatus for converting electrical energy into mechanical energy for operating another apparatus.

Cooling fan: An apparatus with blades for cooling an electronic control box.

Electric cable: Cable for recovering energy and supplying the same to an electric motor from a battery during deceleration and braking.

### DISCLOSURE

### Technical Problem

In the case of a so-called plug-in hybrid electric vehicle which uses both an electric motor powered by an external power source and a gasoline engine, or a plug-in hybrid electric vehicle of an electric vehicle or a hybrid vehicle, which uses both an electric motor powered by an external power source and a gasoline engine, it may be possible to drive the vehicle a maximum distance of 37 km on a single charge and, when a cable is connected to a charging port located on the opposite side of the vehicle relative to the fuel filler inlet, it is possible to charge an electric vehicle using a general 220 V socket, unlike other electric vehicles.

In the case of a plug-in hybrid electric vehicle or an electric vehicle

There is a problem of insufficient infrastructure for charging electric vehicles.

A battery fundamentally determines the driving distance and performance of a vehicle.

A lithium-ion battery has a high battery discharge rate, which impedes the commercialization of electric vehicles. In contrast, the Ryden Battery is formed of organic cotton with a modified carbon-fiber structure. Accordingly, Ryden Battery achieves a high charging rate and a low discharge rate. In addition, the Ryden Battery is known to be capable of being repeatedly recharged and discharged 3000 times or more. Power Japan Plus forecasts that it will be possible to drive a vehicle for about 483 km on a single charge.

The above problems with the plug-in hybrid electric vehicle and the electric vehicle are summarized below.

1) Insufficient charging infrastructure

2) Requirement to increase a charging rate and decrease a discharge rate

3) Requirement to extend a maximum driving distance on a single charge, etc.

4) Although there is a patent disclosing separation and charging of a battery to separately charge the battery as an example of the prior art, there is no carrier-type battery capable of being conveniently transferred in consideration of the weight of the battery.

5) The object of the present invention is to use a carrier-type battery, for driving a wheel of a carrier using power of the carrier-type battery to a house after parking an electric vehicle, an electric aircraft, or the like, or to use the carrier-type battery as a transfer device for a short distance to a space containing a socket in a house or an office with a user standing or sitting on the carrier-type battery.

In addition, another object of the present invention is to charge technologically available vehicles such as an electric aircraft, electric vessel, electric submarine or the like using the same method.

### Technical Solution

The technical solution is provide a plug-and-socket-type power connection device for installing a battery inside a vehicle including an electric vehicle (including a passenger car, a bus, and a truck), a plug-in hybrid vehicle, a general vehicle, an electric aircraft, an electric vessel, or an electric submarine, wherein the battery of the vehicle is wholly removed from a position at which the battery is installed and is then inserted into the position at which the battery is installed and is connected to the plug-and-socket-type power connection device.

The battery of the vehicle may be formed inside a bag of a carrier with a wheel installed thereon.

The bag of the carrier including the battery formed inside the bag of the carrier with a handle extracted and protruding therefrom may be wholly extracted from a socket-and-plug-type installation device, a door formed on a front, lateral, or rear surface of the vehicle is opened. The door for inserting the battery may be a hinged door for facilitating movement of the carrier to a position of the vehicle into which the battery is inserted, and may be converted into an inclined plate, or a plate functioning as an inclined plate is installed or formed inside the door for inserting the battery, the door for inserting the battery may be opened to extract the plate functioning as the inclined plate from the door and to convert the plat into the inclined plate, the carrier may be pushed upwards along the inclined plate to install the carrier at the position of the vehicle at which the battery is installed, a plug-and-socket-type power connector may be formed at one side of the carrier and may be inserted to be connected to a socket-and-plug-type power connector formed at the position of the vehicle at which the battery is installed, after which the carrier may be fixed by a holder.

For charging, a carrier including a battery installed therein may be removed from the vehicle and may be brought into a house, and a plug formed in the carrier may be inserted into a home socket or a socket of a working place to charge the battery, and when the battery is sufficiently charged during a break or bedtime at home or after the plug is inserted into a socket of a working place to charge the battery, the plug may be removed and the carrier may be moved to the vehicle and may be connected to a power connector of the vehicle, and the battery may be used as power of the vehicle.

### Advantageous Effects

According to the advantageous effects of the present invention, 1) without infrastructure for charging, a battery may be charged for a sufficient time during a break at home or working time in a working place, the battery may be brought to a vehicle including an automobile, an electric aircraft, an electric vessel, an electric submarine, or the like, and a plug may be inserted into a power connector of the vehicle, in which case it is not required to worry about a charging place or a charging time, and the problems of 2) a discharge rate and a discharging time, and 3) extension of a maximum driving distance on a single charge may be overcome because sufficient power to be used for one day is easily obtained every day without a separate charging time by charging a battery for a sufficient time at home or in a working place, bringing the battery to a vehicle including an automobile, an electric aircraft, an electric vessel, an electric submarine, or the like, and inserting a plug of the battery into a power connector of the vehicle including an automobile, an electric aircraft, an electric vessel, an electric submarine, or the like.

### DESCRIPTION OF DRAWINGS

FIG. 1 is a perspective view of an electric passenger car according to the present invention.

FIG. 2 is another perspective view of an electric bus according to an exemplary embodiment of the present invention.

FIG. 3 illustrates the case in which a carrier including a battery installed therein is inserted into a socket inside a home.

FIG. 4 illustrates the case in which a drive motor is installed in a carrier including a battery installed thereon and a seat is formed in such a way that a user rides the carrier while sitting on the seat and moves to an electric socket at home or in a working place.

FIG. 5 illustrates the case in which a surface is formed at a lower portion of a carrier including a battery installed therein to be moved by a drive motor according to an embodiment of the present invention.

### BEST MODE

An auxiliary battery may be formed and a traction battery may also be separately formed in a vehicle including an automobile, an electric aircraft, an electric vessel, or an electric submarine, when a carrier including a battery as a traction battery includes two or more wheels and a handle is formed at a front portion of the carrier and turns the carrier to the left or right to control a direction of the carrier, a seat may be formed on the carrier to allow a user to move while sitting on the carrier, and a plate functioning as an inclined plate may be installed or formed inside a door for inserting the battery to enable the carrier to be easily put into a trunk of the vehicle, or the door for inserting the battery and a holder may be formed to fix the carrier so as to prevent the same from moving.

As such, to charge the battery after the vehicle is parked, a user may remove the carrier including the battery installed therein from the vehicle, may ride the carrier, may charge the battery of the carrier for a sufficient time at home or a working place, may sit and ride the carrier while bringing the carrier back to the vehicle including an automobile, an electric aircraft, an electric vessel, or an electric submarine to insert a plug of the carrier into a power connector of the vehicle, and thus the battery may be easily charged every day without a separate charging time and without infrastructure for charging, thereby contributing to the popularization of electric vehicles.

### MODE FOR INVENTION

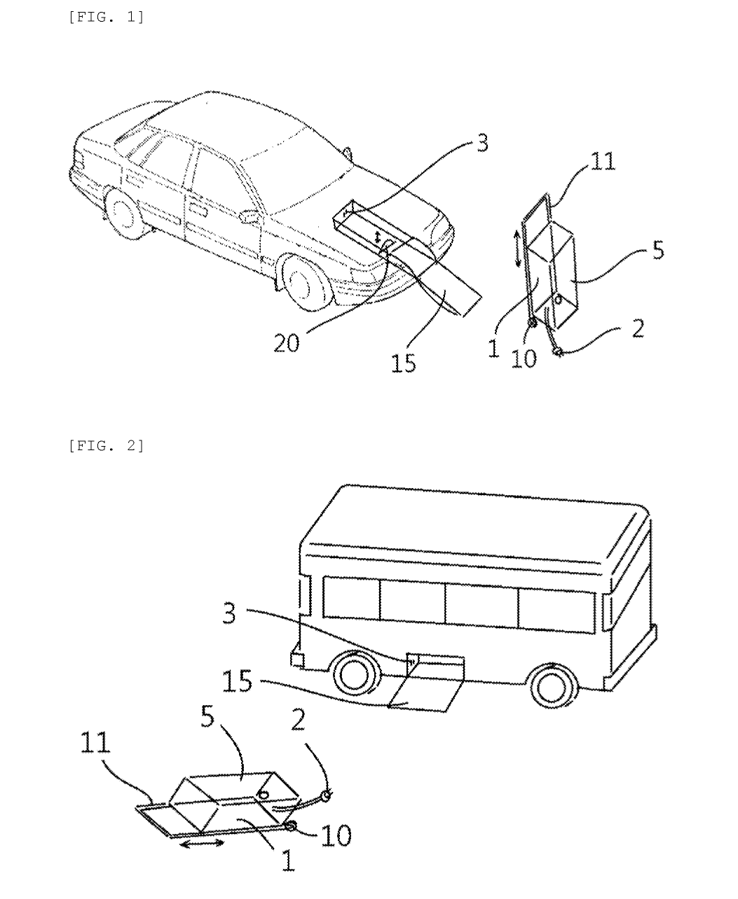

The present invention will now be described more fully with reference to the accompanying drawings, in which exemplary embodiments of the invention are shown. FIG. 1 is a perspective view of an electric car according to the present invention.

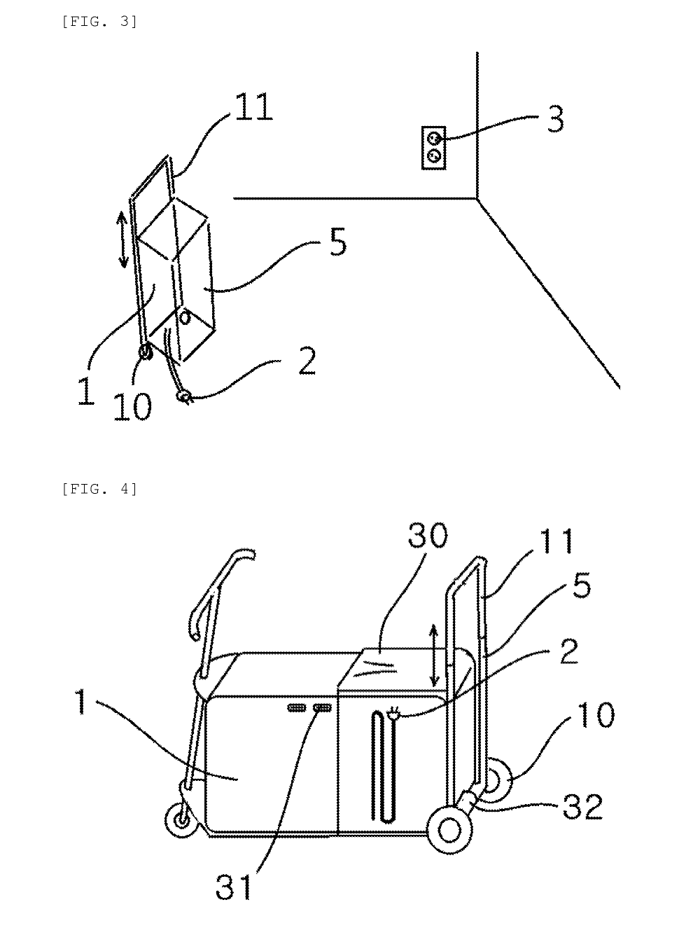

FIG. 2 is another perspective view of an electric bus according to an exemplary embodiment of the present invention.

A plug-and-socket-type power connection device for installing a battery inside a vehicle including an electric vehicle (including a passenger car, a bus, and a truck), a plug-in hybrid vehicle, a general vehicle, an electric aircraft, an electric vessel, or an electric submarine may be provided and, in this case, the battery of the vehicle may be wholly removed from a position at which the battery is installed and may be then inserted into the position at which the battery is installed and may be connected to the plug-and-socket-type power connection device.

The battery of the vehicle may be formed inside a bag of a carrier with a wheel installed thereon.

The bag of the carrier including the battery formed inside the bag of the carrier with a handle extracted and protruding therefrom may be wholly extracted from a socket-and-plug-type installation device, a door formed on a front, lateral, or rear surface of an automobile or a technologically available vehicle including an electric aircraft, an electric vessel, and an electric submarine is opened. The door for inserting the battery may be a hinged door for facilitating movement of the carrier to a position of the vehicle into which the battery is inserted, and may be converted into an inclined plate, or a plate functioning as an inclined plate is installed or formed inside the door for inserting the battery, the door for inserting the battery may be opened to extract the plate functioning as the inclined plate from the door and to convert the plat into the inclined plate, the carrier may be pushed upwards along the inclined plate to install the carrier at the position of the vehicle at which the battery is installed, a plug-and-socket-type power connector may be formed at one side of the carrier and may be inserted to be connected to a socket-and-plug-type power connector formed at the position of an automobile or a technologically available vehicle including an electric aircraft, an electric vessel, and an electric submarine at which the battery is installed, after which the carrier may be fixed by a holder.

For charging, a carrier including a battery installed therein may be removed from the vehicle including an automobile, an electric aircraft, an electric vessel, or an electric submarine and may be brought into a house, and a plug formed in the carrier may be inserted into a home socket or a socket of a working place to charge the battery, and when the battery is sufficiently charged during a break or bedtime at home or after the plug is inserted into a socket of a working place to charge the battery, the plug may be removed and the carrier may be moved to the vehicle including an automobile, an electric aircraft, an electric vessel, or an electric submarine and may be connected to a power connector of the vehicle including an automobile, an electric aircraft, an electric vessel, or an electric submarine, and the battery may be used as power of the vehicle.

FIG. 3 illustrates the case in which a carrier including a battery installed therein is inserted into a socket inside a home.

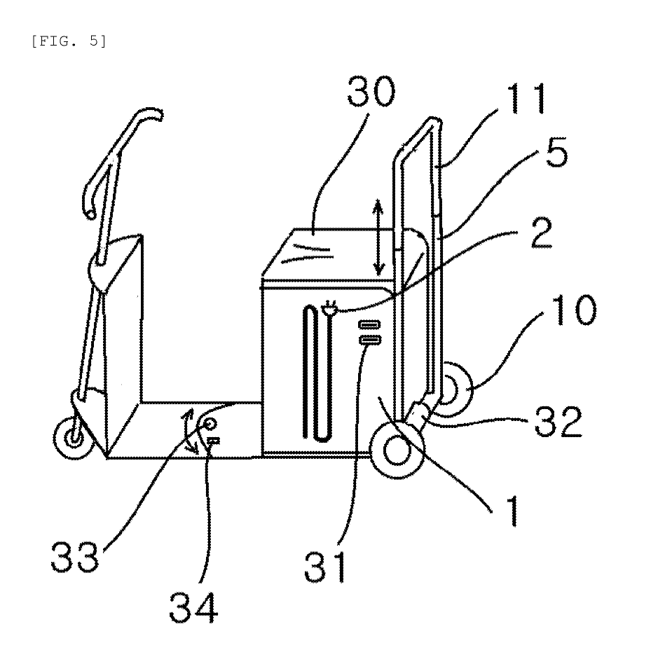

FIG. 4 illustrates the case in which a drive motor is installed in a carrier including a battery installed thereon and a seat is formed in such a way that a user rides the carrier while sitting on the seat and moves to an electric socket at home or in a working place.

Referring to FIG. 5, the wheel of the carrier including the battery installed therein may be driven by an electric motor and a switch may be formed at one side of the carrier.

The carrier including the battery installed therein may include three wheels, and a handle may be formed at a front portion of the carrier and may turn the carrier to the left or right to control the direction of the carrier.

A surface may be formed at a lower portion of the carrier including the battery installed therein to allow a foot to be put thereon, three wheels may be formed on the surface to allow a user to move while putting a foot on the surface at the lower portion of the carrier, the surface may include a folded portion for folding the surface into two pieces and unfolding the surface and a holder for fixing the surface while folding and unfolding the surface, and after folding, the handle may be held and pulled similar to a general method of moving a carrier, or the switch of the drive motor may be turned on to move the carrier.

The above embodiments are therefore to be construed in all aspects as illustrative and not restrictive. The scope of the invention should be determined by the appended claims and their legal equivalents, rather than by the above description, and all changes falling within the meaning and equivalency range of the appended claims are intended to be embraced therein.

Therefore, the present invention intends not to limit the embodiments disclosed herein but to encompass the broadest range matching the principles and new features disclosed herein.

### INDUSTRIAL APPLICABILITY

To charge the battery after the vehicle is parked, a user may remove the carrier including the battery installed therein from the vehicle, may ride the carrier, may charge the battery of the carrier for a sufficient time at home or a working place, may sit and ride the carrier while bringing the carrier back to the vehicle including an automobile, an electric aircraft, an electric vessel, or an electric submarine to insert a plug of the carrier into a power connector of the vehicle, and thus the battery may be easily charged every day without a separate charging time and without infrastructure for charging, thereby contributing to the popularization of electric vehicles,

1. A battery-charging device for a vehicle including an electric vehicle, an electric aircraft, an electric vessel, or an electric submarine, comprising: a plug-and-socket-type power connection device for installing a battery inside a vehicle including an electric vehicle (including a passenger car, a bus, and a truck), a plug-in hybrid vehicle, a general vehicle, an electric aircraft, an electric vessel, or an electric submarine,
wherein the battery of the vehicle is wholly removed from a position at which the battery is installed and is then inserted into the position at which the battery is installed and is connected to the plug-and-socket-type power connection device.

2. The battery-charging device of claim 1, wherein:
the battery of the vehicle is formed inside a bag of a carrier with a wheel installed thereon; and
the bag of the carrier including the battery formed inside the bag of the carrier with a handle formed thereon or a handle extracted and protruding therefrom is wholly extracted along with a plug from a socket-and-plug-type installation device, a door formed on a front, lateral, or rear surface of the vehicle is opened, and the carrier is inserted into the door.

3. The battery-charging device of claim 2, wherein the door for inserting the battery is a hinged door for facilitating movement of the carrier to a position of the vehicle into which the battery is inserted, and is converted into an inclined plate, or a plate functioning as an inclined plate is installed or formed inside the door for inserting the battery, the door for inserting the battery is opened to extract the plate functioning as the inclined plate from the door and to convert the plat into the inclined plate, the carrier is pushed upwards along the inclined plate by a manual or drive motor to install the carrier at the position of the vehicle at which the battery is installed, a plug-and-socket-type power connector is formed at one side of the carrier and is inserted to be connected to a socket-and-plug-type power connector formed at the position of the vehicle at which the battery is installed.

4. The battery-charging device of claim 3, wherein a plug-and-socket-type power connector is formed at one side of the carrier and is inserted to be connected to a socket-and-plug-type power connector formed at the position of the vehicle at which the battery is installed, and then the carrier is fixed by a holder formed for fixing the carrier.

5. A battery-charging method of a vehicle including an electric vehicle, an electric aircraft, an electric vessel, or an electric submarine, the method using a plug-and-socket-type power connection device for installing a battery inside a vehicle including an electric vehicle (including a passenger car, a bus, and a truck), a plug-in hybrid vehicle, a general vehicle, an electric aircraft, an electric vessel, or an electric submarine,
wherein the battery of the vehicle is wholly removed from a position at which the battery is installed and is then inserted into the position at which the battery is installed and is connected to the plug-and-socket-type power connection device.

6. The method of claim 5, wherein:
the battery of the vehicle is formed inside a bag of a carrier with a wheel installed thereon; and
the bag of the carrier including the battery formed inside the bag of the carrier with a handle formed thereon or a handle extracted and protruding therefrom is wholly extracted along with a plug from a socket-and-plug-type installation device, a door formed on a front, lateral, or rear surface of the vehicle is opened, and the carrier is inserted into the door.

7. The method of claim 6, wherein the door for inserting the battery is a hinged door for facilitating movement of the carrier to a position of the vehicle into which the battery is inserted, and is converted into an inclined plate, or a plate functioning as an inclined plate is installed or formed inside the door for inserting the battery, the door for inserting the battery is opened to extract the plate functioning as the inclined plate from the door and to convert the plat into the inclined plate, the carrier is pushed upwards along the inclined plate by a manual or drive motor to install the carrier at the position of the vehicle at which the battery is installed, a plug-and-socket-type power connector is formed at one side of the carrier and is inserted to be connected to a socket-and-plug-type power connector formed at the position of the vehicle at which the battery is installed.

8. The method of claim 7, wherein a plug-and-socket-type power connector is formed at one side of the carrier and is inserted to be connected to a socket-and-plug-type power connector formed at the position of the vehicle at which the battery is installed, and then the carrier is fixed by a holder formed for fixing the carrier.

9. A battery-charging method of a vehicle including an automobile, an electric aircraft, an electric vessel, or an electric submarine, wherein:
for charging, a carrier including a battery installed therein is removed from the vehicle and is brought into a house, and a plug formed in the carrier is inserted into a home socket to charge the battery; and
when the battery is sufficiently charged during a break or bedtime at home or after the plug is inserted into a socket of a working place to charge the battery, the plug is removed and the carrier is moved to an automobile or a technologically available vehicle including an electric aircraft, an electric vessel, and an electric submarine and is connected to a power connector of the vehicle, and the battery is used as power of the vehicle.

10. The battery-charging device of claim 9, wherein the plug includes a unit for winding an electric cable and inputting and removing the electric cable into and from the carrier.

11. The battery-charging device of claim 10, wherein the wheel of the carrier is driven by an electric motor and a switch is formed at one side of the carrier,
wherein the carrier includes two or more wheels and a handle is formed at a front portion of the carrier and turns the carrier to the left or right to control a direction of the carrier, and a seat is formed on the carrier to allow a user to move while sitting on the carrier.

12. (canceled)

13. The battery-charging device of claim 11, wherein a surface is formed at a lower portion of the carrier to allow a foot to be put thereon, and two or more wheels are formed on the surface to allow a user to move while putting the foot on the surface at the lower portion of the carrier.

14. (canceled)

15. The battery-charging device of claim 13, wherein the carrier further includes a cooling device.

16. The battery-charging device of claim 15, wherein the carrier further includes a battery controller.

17. The battery-charging device claim 16, wherein an auxiliary battery is formed in the vehicle.

18. The battery-charging device of claim 9, wherein the plug includes a unit for winding an electric cable and inputting and removing the electric cable into and from the carrier, the wheel of the carrier is driven by an electric motor and a switch is formed at one side of the carrier, the carrier includes a cooling device, or the carrier further includes a battery controller, and an auxiliary battery is formed and a traction battery is also separately formed in the vehicle,
wherein the carrier further includes an AC/DC adaptor.

19-20. (canceled)

21. The battery-charging device of claim 18, wherein the vehicle or the carrier further includes a charging plug for charging to charge the battery installed in the carrier or an auxiliary battery by a charger at an electric charging station similar to a general charging method of an electric vehicle.

22. The method of claim 21, wherein the vehicle or the carrier further includes a charging plug for charging to charge the battery installed in the carrier or an auxiliary battery by a charger at an electric charging station similarly to a general charging method of an electric vehicle or the carrier is removed from the vehicle to charge the battery with home electricity.

23. (canceled)

24. The battery-charging device of claim 22, wherein the carrier further includes a USB port.

25. The battery-charging device of claim 24, wherein an auxiliary battery is formed and a traction battery is also separately formed in the vehicle,
wherein the traction battery is connected in parallel to a traction battery of the carrier and a switch is formed at a connection portion.

26. (canceled)
